(19) United States
(12) Patent Application Publication
(10) Pub. No.: US 2024/0246531 A1
(43) Pub. Date: Jul. 25, 2024

(54) AUTONOMOUS VEHICLES OPERATING IN ROAD TUNNELS AND SIGNAL INTERRUPTION

(71) Applicant: Volvo Car Corporation, Göteborg (SE)

(72) Inventors: Anders Lennartsson, Gothenburg (SE); Oswaldo Perez Barrera, Gothenburg (SE)

(21) Appl. No.: 18/159,242

(22) Filed: Jan. 25, 2023

(51) Int. Cl. B60W 30/09; B60W 60/00

(52) U.S. Cl. CPC B60W 30/09; B60W 60/0015; B60W 2556/45

(57) ABSTRACT

Various systems and methods are presented regarding utilizing technology onboard an autonomous vehicle (AV) to mitigate the effects of communication signals being deleteriously affected/lost when the AV is navigating a road tunnel (e.g., where the AV is operating partially autonomously or autonomously). Prior to entering the tunnel, the AV can receive information regarding the length of the tunnel, etc., which the AV can then utilize to self-navigate the tunnel.

To improve communications while in the tunnel, a second vehicle can act as a communication relay between the AV and an external navigation system (e.g., GNSS). The AV can also request an occupant drive the vehicle through the tunnel. In the event of an accident, the AV can transmit status reports to external entities such as police, traffic department, and suchlike.

### TECHNICAL FIELD

This application relates to techniques facilitating operation of a vehicle when communications have been compromised while driving through a road tunnel.

### BACKGROUND

Operation of an autonomous vehicle (AV) can require communications between the AV and external systems, such as a Global Navigation Satellite System (GNSS), a Global Positioning System (GPS), a navigation system, a vehicle monitoring system, and suchlike. However, communication(s) between the AV and the external system can be compromised when the AV is driving through a road tunnel, where such compromised operation can lead to a weakening of signal strength or complete loss of signals between the AV and the external system(s). Compromising the signal can result in loss of navigation of the AV as well as inability to provide status updates regarding events such as a current operating condition of the AV, an accident involving the AV or detected by the AV, a road condition within the tunnel, and suchlike.

The above-described background is merely intended to provide a contextual overview of some current issues and is not intended to be exhaustive. Other contextual information may become further apparent upon review of the following detailed description.

### SUMMARY

The following presents a summary to provide a basic understanding of one or more embodiments described herein. This summary is not intended to identify key or critical elements, or delineate any scope of the different embodiments and/or any scope of the claims.

The sole purpose of the summary is to present some concepts in a simplified form as a prelude to the more detailed description presented herein.

In one or more embodiments described herein, systems, devices, computer-implemented methods, methods, apparatus and/or computer program products are presented that facilitate safe operation of a vehicle that is being operated at least partially autonomously (AV) when there has been a loss in quality of navigation signals received by the AV.

According to one or more embodiments, a system is provided to provide safe operation of an AV in the event of loss of navigation signals, e.g., when the AV s driving through a tunnel. The system can be located on a first vehicle operating in an at least partially autonomous manner. The system can comprise a memory that stores computer executable components and a processor that executes the computer executable components stored in the memory. The computer executable components can comprise a signal detection component configured to determine a signal quality of first navigation signals received at the first vehicle, wherein the first navigation signals are received from a first external system. In a further embodiment, in response to determining the first navigation signals have a signal quality below a threshold of acceptable operation, generate an instruction for the first vehicle to operate utilizing second navigation signals generated by at least one onboard sensor. In an embodiment, the signal quality of the first navigation signals being below the threshold of acceptable operation is a function of occlusion of the first navigation signals due to the first vehicle driving in a tunnel. In an embodiment, the first external system can be configured to transmit the first navigation data to the first vehicle, and can comprise any of a global navigation satellite system (GNSS), a global positioning system (GPS), an autonomous geo-spatial positioning system, or a satellite-based positioning, navigation and timing (PNT) system.

In a further embodiment, the system can further comprise an incident component configured to detect the first vehicle stopping. In an embodiment, the first vehicle may have stopped as a result of the first vehicle being involved in a collision, while the first vehicle was being driven in a self-navigating mode. In another embodiment, the incident component can be further configured to generate a status report, the status report can include information regarding at least one of model type of the first vehicle, license plate number of the first vehicle, a situation report of the first vehicle, a location of the first vehicle, a contact, a contact telephone number, or information regarding an occupant of the first vehicle.

In a further embodiment, the system can further comprise a communication component configured to establish communication with an external communication system, wherein the external communication system can be located on a second vehicle. The communication component can be further configured to transmit the status report to the external communication system located on the second vehicle. In a further embodiment, the communication component can be further configured to instruct the external communication system on the second vehicle to forward the status report to a second external system. In an embodiment, the second external system can be a cloud-based computing system or a remotely located communication system, wherein the second external system can be configured to forward the status report to an entity identified in the status report.

In other embodiments, elements described in connection with the disclosed systems can be embodied in different forms such as computer-implemented methods, computer program products, or other forms. For example, in an embodiment, a computer-implemented method can be utilized to determine, by a device comprising a processor located on a vehicle, a first signal quality of first signals received at the vehicle is below a threshold of signal quality for acceptable risk of operation of the vehicle, wherein the first signals comprise first data transmitted from an external system. In another embodiment, the method can further comprise switching navigation of the vehicle from operation with the first data received from the external system to operation with second signals comprising second data generated by a first sensor located onboard the vehicle. In an embodiment, the first signals can be received while the vehicle is driving through a tunnel.

In a further embodiment, the method can further comprise determining, by a second onboard sensor, that the vehicle has stopped, and in response to determining that the vehicle has stopped, generating a status report detailing a current situation of the vehicle. The current situation can be any one of the vehicle is unable to drive with an acceptable level of safety while navigating with the second signals or the vehicle is involved in a collision. In an embodiment, the status report can configured to be transmitted, via an external communication service, to at least one entity, wherein the entity can be one of an insurance company, a medical service, a highway patrol, an emergency contact, a global navigation satellite system, or a global positioning system, wherein the status report includes an identifier identifying the entity to receive the status report. The method can further comprise determining the vehicle has an occupant and requesting the occupant operates the vehicle.

In a further embodiment, the method can further comprise identifying a second vehicle within communication range of the vehicle, wherein the second vehicle includes an onboard communication system configured to communicate with the external communication service. The method can further comprise transmitting the combination of status report and identifier to the second vehicle and further instructing the second vehicle to transmit the status report to the external communication system, and further instructing the second vehicle to transmit a transmission success notification to the vehicle in response to the second vehicle successfully transmitting the status report to the external communication service.

In another embodiment, a computer program product can comprise a computer readable storage medium having program instructions embodied therewith, the program instructions can be executable by a processor, causing the processor to monitor signal strength of first signals received at a vehicle operating in an at least partially autonomous manner, wherein the first signals are received from an external system and are utilized for navigation of the vehicle. The program instructions can be further configured to determine a drop in the signal strength of the first signals from a first signal strength to a second signal strength, wherein the first signal strength is acceptable for the at least partially autonomous operation of the vehicle based on the first signals and the second signal strength is below a threshold acceptable for the at least partially autonomous operation of the vehicle based on the first signals and switch navigation of the vehicle to be based on second signals, wherein the second signals are sourced from at least one sensor located onboard the vehicle. The drop of signal strength of the first signals from the first strength to the second strength can result from the vehicle driving in a road tunnel.

The program instructions can be further configured to determine the vehicle has stopped in a road tunnel, wherein the vehicle may have stopped owing to the vehicle is no longer able to navigate the road tunnel in the at least partially autonomous manner or the vehicle is involved in a collision inside the road tunnel. The program instructions can be further configured to generate a status report, identify a second vehicle driving in the road tunnel and transmitting the status report to the second vehicle, wherein the second vehicle is configured to transmit the status report to an external system, wherein the external system is located outside of the road tunnel.

An advantage of the one or more systems, computer-implemented methods and/or computer program products can be enabling access and/or operation of an AV where a degradation of signal quality has occurred regarding navigation signals received from an external system, such as GNSS, GPS, etc. The AV can attempt to self-navigate utilizing signals/data received from onboard sensors. In the event of the AV cannot self-navigate to a safe level of operation, the AV can cease operation, hand over operation to an occupant, etc. Further, in the event of an accident, the AV can generate/transmit a status report(s) to enable provision of assistance to the AV.

### DESCRIPTION OF THE DRAWINGS

One or more embodiments are described below in the Detailed Description section with reference to the following drawings.

FIG. 1 illustrates a system that can be utilized by an AV to navigate a road tunnel where it may not be possible to maintain continuous communications with the external navigation system, in accordance with one or more embodiments.

FIGS. 2A-D present images illustrating respective situations regarding a vehicle navigating a road tunnel, according to at least one embodiment.

FIG. 3 is a schematic of a vehicle navigating a tunnel, according to one or more embodiments.

FIGS. 4A-B present example status reports that can be transmitted, in accordance with one or more embodiments.

FIG. 5 presents example information that can be presented on an onboard display when an AV is involved in an accident, in accordance with at least one embodiment.

FIG. 6 is a schematic presenting an example scenario of information in a status report being distributed to various entities, in accordance with an embodiment.

FIG. 7 illustrates a flow diagram for a computer-implemented methodology for a vehicle being operated autonomously while driving in a tunnel, in accordance with at least one embodiment.

FIG. 8 illustrates a flow diagram for a computer-implemented methodology for determining the nearest exit of a tunnel, in accordance with at least one embodiment.

FIG. 9 illustrates a flow diagram for a computer-implemented methodology for determining whether an AV should go to self-navigating mode based on signal strength, in accordance with at least one embodiment.

FIG. 10 is a block diagram illustrating an example computing environment in which the various embodiments described herein can be implemented.

FIG. 11 is a block diagram illustrating an example computing environment with which the disclosed subject matter can interact, in accordance with an embodiment.

FIG. 12 presents TABLE 1200 presenting a summary of SAE J3016 detailing respective functions and features during Levels 0-5 of driving automation (per June 2018).

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section, Summary section, and/or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It is to be understood that when an element is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling. Likewise, it is to be understood that when an element is referred to as being “connected” to another element, it can describe one or more different types of connecting including, but not limited to, electrical connecting, electromagnetic connecting, operative connecting, optical connecting, physical connecting, thermal connecting, and/or another type of connecting.

As used herein, “data” can comprise metadata. Further, ranges A-n are utilized herein to indicate a respective plurality of devices, components, signals etc., where n is any positive integer.

In the various embodiments presented herein, the disclosed subject matter can be directed to utilizing one or more components located on an autonomous vehicle (AV) being operated in an autonomous manner, wherein the one or more components can be utilized to operate/navigate the AV when navigation signals from an external system (e.g., from a GNSS) have been lost or are deleteriously impacted. In an embodiment, signals received from one or more onboard sensors can be utilized to replace and/or supplement the navigation signals from the external system having been lost or the signal quality is below a threshold for safe operation of the AV.

Further, while the various embodiments presented herein are presented regarding operating an AV in a road tunnel, and the road tunnel is occluding signals from an external system with the according loss of the external signals, the various embodiments can be utilized in any applicable scenario where signal loss can occur, e.g., in a city (e.g., buildings are occluding the signals being transmitted from the external system), a wooded area, mountains, or any environment where continuity of signal reception is negatively affected/cannot be guaranteed.

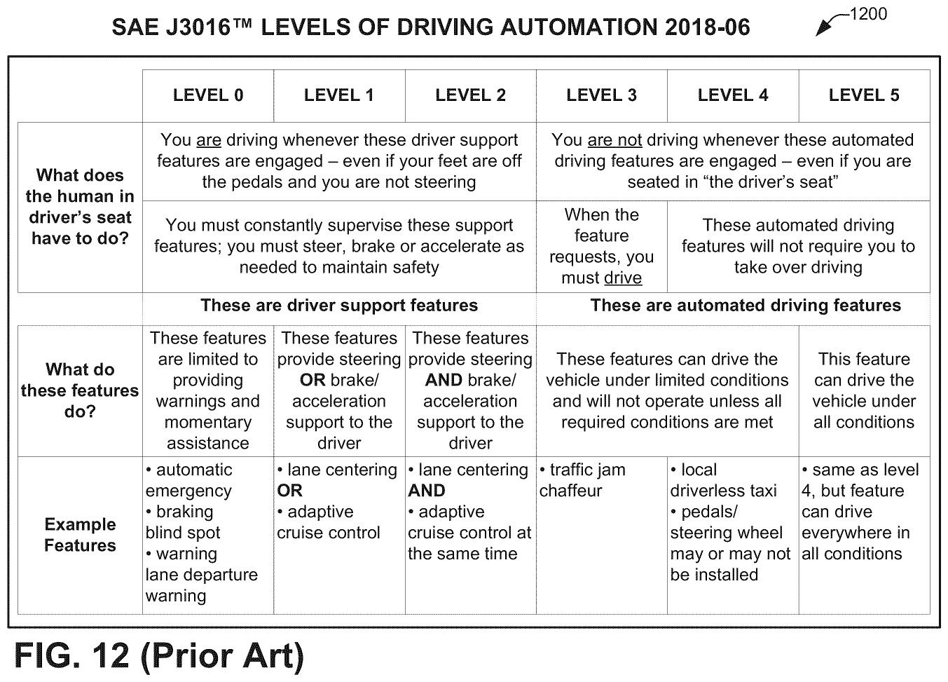

Regarding the phrase “autonomous” operation, to enable the level of sophistication of operation of a vehicle to be defined across the industry by both suppliers and policymakers, standards are available to define the level of autonomous operation. For example, the International Standard J3016 Taxonomy and Definitions for Terms Related to Driving Automation Systems for On-Road Motor Vehicles has been developed by the Society of Automotive Engineers (SAE) and defines six levels of operation of a driving automation system(s) that performs part or all of the dynamic driving task (DDT) on a sustained basis. The six levels of definitions provided in SAE J3016 range from no driving automation (Level 0) to full driving automation (Level 5), in the context of vehicles and their operation on roadways. Levels 0-5 of SAE J3016 are summarized below and further presented in FIG. 12, Table 1200.

Level 0 (No Driving Automation): At Level 0, the vehicle is manually controlled with the automated control system (ACS) having no system capability, the driver provides the DDT regarding steering, braking, acceleration, negotiating traffic, and suchlike. One or more systems may be in place to help the driver, such as an emergency braking system (EBS), but given the EBS technically doesn't drive the vehicle, it does not qualify as automation. The majority of vehicles in current operation are Level 0 automation.

Level 1 (Driver Assistance/Driver Assisted Operation): This is the lowest level of automation. The vehicle features a single automated system for driver assistance, such as steering or acceleration (cruise control) but not both simultaneously. An example of a Level 1 system is adaptive cruise control (ACC), where the vehicle can be maintained at a safe distance behind a lead vehicle (e.g., operating in front of the vehicle operating with Level 1 automation) with the driver performing all other aspects of driving and has full responsibility for monitoring the road and taking over if the assistance system fails to act appropriately.

Level 2 (Partial Driving Automation/Partially Autonomous Operation): The vehicle can (e.g., via an advanced driver assistance system (ADAS)) steer, accelerate, and brake in certain circumstances, however, automation falls short of self-driving as tactical maneuvers such as responding to traffic signals or changing lanes can mainly be controlled by the driver, as does scanning for hazards, with the driver having the ability to take control of the vehicle at any time.

Level 3 (Conditional Driving Automation/Conditionally Autonomous Operation): The vehicle can control numerous aspects of operation (e.g., steering, acceleration, and suchlike), e.g., via monitoring the operational environment, but operation of the vehicle has human override. For example, the autonomous system can prompt a driver to intervene when a scenario is encountered that the onboard system cannot navigate (e.g., with an acceptable level of operational safety), accordingly, the driver must be available to take over operation of the vehicle at any time.

Level 4 (High Driving Automation/High Driving Operation): advancing on from Level 3 operation, while under Level 3 operation the driver must be available, with Level 4, the vehicle can operate without human input or oversight but only under select conditions defined by factors such as road type, geographic area, environments limiting top speed (e.g., urban environments), wherein such limited operation is also known as “geofencing”. Under Level 4 operation, a human (e.g., driver) still has the option to manually override automated operation of the vehicle.

Level 5 (Full Driving Automation/Full Driving Operation): Level 5 vehicles do not require human attention for operation, with operation available on any road and/or any road condition that a human driver can navigate (or even beyond the navigation/driving capabilities of a human). Further, operation under Level 5 is not constrained by the geofencing limitations of operation under Level 4. In an embodiment, Level 5 vehicles may not even have steering wheels or acceleration/brake pedals. In an example of use, a destination is entered for the vehicle (e.g., by a passenger, by a supply manager where the vehicle is a delivery vehicle, and suchlike), wherein the vehicle self-controls navigation and operation of the vehicle to the destination.

To clarify, operations under levels 0-2 can require human interaction at all stages or some stages of a journey by a vehicle to a destination. Operations under levels 3-5 do not require human interaction to navigate the vehicle (except for under level 3 where the driver is required to take control in response to the vehicle not being able to safely navigate a road condition).

As referenced herein, DDT relates to various functions of operating a vehicle. DDT is concerned with the operational function(s) and tactical function(s) of vehicle operation, but may not be concerned with the strategic function. Operational function is concerned with controlling the vehicle motion, e.g., steering (lateral motion), and braking/acceleration (longitudinal motion). Tactical function (aka, object and event detection and response (OEDR)) relates to the navigational choices made during a journey to achieve the destination regarding detecting and responding to events and/or objects as needed, e.g., overtake vehicle ahead, take the next exit, follow the detour, and suchlike. Strategic function is concerned with the vehicle destination and the best way to get there, e.g., destination and way point planning. Regarding operational function, a Level 1 vehicle under SAE J3016 controls steering or braking/acceleration, while a Level 2 vehicle must control both steering and braking/acceleration. Autonomous operation of vehicles at Levels 3, 4, and 5 under SAE J3016 involves the vehicle having full control of the operational function and the tactical function. Level 2 operation may involve full control of the operational function and tactical function but the driver is available to take control of the tactical function.

Accordingly, the term “autonomous” as used herein regarding operation of a vehicle with or without a human available to assist the vehicle in self-operation during navigation to a destination, can relate to any of Levels 1-5. In an embodiment, for example, the terms “autonomous operation” or “autonomously” can relate to a vehicle operating at least with Level 2 operation, e.g., a minimum level of operation is Level 2: partially autonomous operation, per SAE J3016. Hence, while Level 2, partially autonomous operation, may be a minimum level of operation, higher levels of operation, e.g., Levels 3-5, are encompassed in operation of the vehicle at Level 2 operation. Similarly, a minimum Level 3 operation encompasses Levels 4-5 operation, and minimum Level 4 operation encompasses operation under Level 5 under SAE J3016.

It is to be appreciated that while the various embodiments presented herein are directed towards to one or more vehicles (e.g., vehicle 102) operating in an autonomous manner (e.g., as an AV), the various embodiments presented herein are not so limited and can be implemented with a group of vehicles operating in any of an autonomous manner (e.g., Level 5 of SAE J3016), a partially autonomous manner (e.g., Level 1 of SAE J3016 or higher), or in a non-autonomous manner (e.g., Level 0 of SAE J3016). For example, a first vehicle (e.g., vehicle 102) can be operating in an autonomous manner (e.g., any of Levels 3-5), a partially autonomous manner (e.g., any of levels 1-2), or in a non-autonomous manner (e.g., Level 0), while a second vehicle (e.g., vehicle 310) can also be operating in any of an autonomous manner, a partially autonomous manner, or in a non-autonomous manner.

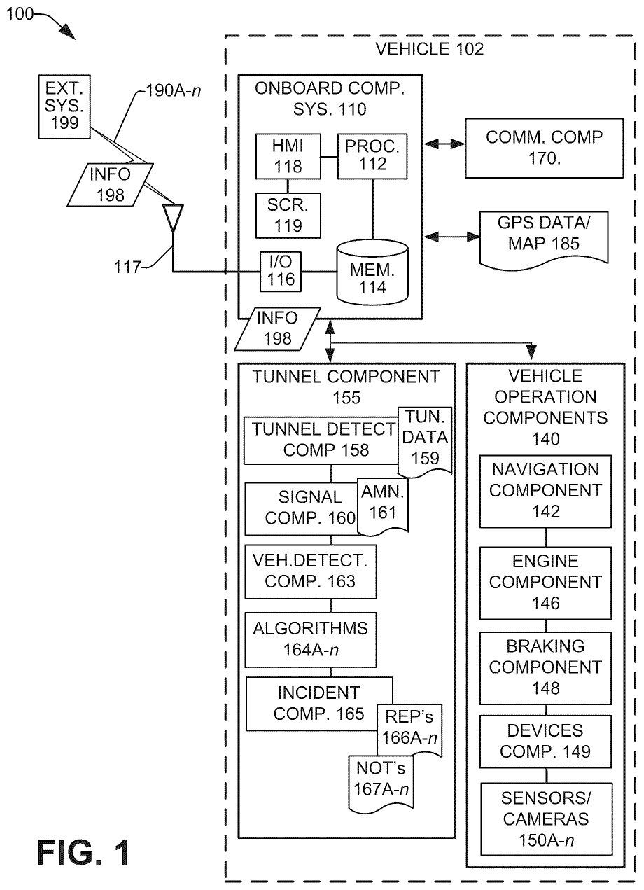

Turning now to the drawings, FIG. 1 illustrates a system 100 that can be utilized by an AV to navigate a road tunnel where it may not be possible to maintain continuous communications with the external system, in accordance with one or more embodiments. System 100 comprises a vehicle 102, wherein, per various embodiments presented herein, the vehicle 102 can be being operated in any of an autonomous, a semi-autonomous, a “self-navigating” (as further described), or a non-autonomous manner. Various devices and components can be located on vehicle 102, such as an onboard computer system (OCS) 110, wherein the OCS 110 can be a vehicle control unit (VCU). The OCS 110 can be utilized to provide overall operational control and/or operation of the EV.

In an embodiment, the OCS 110 can be configured to operate/control/monitor various vehicle operations (e.g., when being operated autonomously, self-navigating, and the like), wherein the various operations can be controlled by one or more vehicle operation components 140 communicatively coupled to the OCS 110. The various vehicle operation components 140 can include a navigation component 142 configured to navigate vehicle 102 along a road, through a tunnel, etc., as well as to control steering of the vehicle 102. In an embodiment, when vehicle 102 is being operated autonomously, the navigation component 142 (in conjunction with OCS 110) can have full operational control of the vehicle 102, e.g., controls the velocity of vehicle 102, controls the steering of vehicle 102, controls braking of vehicle 102, etc. During autonomous operation, the navigation component 142 can operate in accordance with navigation data/information (e.g., in information 198 included in signals 190A-n received from an external system 199, wherein the external system 199 can be a GNSS, a GPS, an autonomous geo-spatial positioning system, a satellite-based positioning, navigation and timing (PNT) system, or other navigation/guidance system). When vehicle 102 is being operated in a semi-autonomous or non-autonomous manner, the navigation component 142 (in conjunction with the OCS 110) can relinquish a portion, or all, of control of the steering, braking, acceleration, etc., to an occupant (e.g., a driver) of the vehicle 102. Further, per one or more embodiments presented herein, when vehicle 102 is being operated in a semi-autonomous or non-autonomous manner, the navigation component 142 (in conjunction with the OCS 110) may not be not 100% reliant on navigation signals 198 being received from the external system 199, but rather can supplement or entirely replace navigation data typically received from the external system 199 with data generated by various onboard sensors and cameras 150A-n.

The vehicle operation components 140 can further comprise an engine component 146 configured to control operation, e.g., start/stop, of an engine configured to propel the vehicle 102. The vehicle operation components 140 can further comprise a braking component 148 configured to slow down or stop the vehicle 102. The vehicle operation components 140 can further include a devices component 149 configured to control operation of any onboard devices, e.g., automatic activation of headlights when entering a tunnel, operation of hazard lights when the vehicle 102 is stopping within a tunnel or is involved in an accident, and the like. The onboard devices can include a device configured to generate an audible signal (e.g., a car horn on the vehicle 102) and/or a visual signal (e.g., headlights on the vehicle 102).

The vehicle operation components 140 can further comprise various sensors and/or cameras 150A-n configured to monitor operation of vehicle 102 and further obtain imagery and other information regarding an environment/surroundings the vehicle 102 is operating in, e.g., a road, entering the tunnel, from within the road tunnel, and the like. The sensors/cameras 150A-n can include any suitable detection/measuring device, including cameras, optical sensors, laser sensors, Light Detection and Ranging (LiDAR) sensors, sonar sensors, audiovisual sensors, perception sensors, road lane sensors, motion detectors, velocity sensors, microphones, and the like, as employed in such applications as simultaneous localization and mapping (SLAM), and other computer-based technologies and methods utilized to determine an environment being navigated by vehicle 102 and the location of the vehicle 102 within the environment (e.g., location mapping). Digital images, data, and the like generated by sensors/cameras 150A-n can be analyzed by algorithms 164A-n to identify respective features of interest such as a tunnel (e.g., lane markings therein), location and motion of passengers inside vehicle 102, whether the vehicle 102 has been involved in an accident, direction of motion of vehicle 102, and the like. In a further embodiment, the sensors/cameras 150A-n can also be utilized to determine a presence of one or more occupants/passengers in the vehicle 102, where such sensors/cameras 150A-n can include seatbelt sensors, seat pressure sensors, motion sensors, and suchlike, which can determine the presence of a person in a seat and/or within the vehicle 102, and further what their physical state may be regarding are they moving, are they unconscious, are they injured, and suchlike. Further, sensors/cameras 150A-n can include an activation sensor that can be utilized to determine an airbag being deployed, e.g., during an accident. Further, sensors/cameras 150A-n can include acceleration/deceleration sensors configured to determine a sudden/abnormal deceleration/stopping of vehicle 102, e.g., as can occur during an accident. The sensors/cameras 150A-n can also be configured to capture images/data regarding another vehicle that has collided with vehicle 102.

As shown, vehicle 102 can further include a tunnel component 155, wherein the tunnel component 155 can further comprise various components that can be utilized to maintain operation of vehicle 102 and/or maintain/supplement communications to/from vehicle 102 when vehicle 102 is (a) approaching, (b) within, and/or (c) exiting a tunnel. As shown in FIG. 1, the tunnel component 155 can be communicatively coupled to the OCS 110, the vehicle operation components 140, and other components located on board vehicle 102.

A tunnel detection component 158 can be included in the tunnel component 155, wherein the tunnel detection component 158 can be configured to identify when vehicle 102 is approaching a tunnel, obtain information regarding the tunnel (e.g., length of the tunnel, number of lanes, and suchlike), obtain information regarding any previously identified issues with the tunnel (e.g., chance of losing communications with an external system(s) is low, medium, high), and suchlike. The tunnel detection component 158 can be configured to receive information/data from the various on-board sensors and cameras 150A-n, as well as provided by algorithms 164A-n, and the like. Information already known about the tunnel and/or generated by the various components and devices located onboard vehicle 102 can be compiled as tunnel data 159. In an embodiment, the tunnel detection component 158 can be configured to analyze information (e.g., digital images, data) from various on-board sensors and cameras 150A-n to identify respective lane markings and suchlike, from which the tunnel detection component 158 can generate tunnel data 159 regarding a road being navigated by the vehicle 102. Accordingly, the tunnel data 159 can include information regarding the width of the tunnel, width of the road, number of lanes forming the road, width of the lane(s), and the like. The tunnel data 159 can be compiled as a function of previous drives through the tunnel by the vehicle 102. The tunnel detection component 158 can further receive information from an onboard GPS data/map system 185, wherein the GPS data/map system 185 can provide information to supplement the tunnel data 159 (e.g., location of a tunnel, number of lanes in the tunnel, width of the road, width of a lane(s), and the like). Further, the tunnel detection component 158 can receive tunnel information from an external system 199 that can further provide information regarding the road being navigated which can further supplement the tunnel data 159. Accordingly, regarding a tunnel that vehicle 102 is about to enter, the tunnel detection component 158 can have minimal information through to a plethora of information based upon the tunnel data 159, the GPS data/map system 185, etc.

A signal component 160 can be included in the tunnel component 155, wherein the signal component 160 can be configured to monitor respective signals 190A-n being received at the vehicle 102, e.g., from an external system 199, such as a GNSS signals, GPS signals, and suchlike. The signal component 160 can be configured to monitor and analyze any suitable parameters regarding the strength, integrity, continuity, signal packet information, etc., of the signals 190A-n to enable the vehicle 102 to operate in a safe/expected manner while entering and driving in a tunnel. As previously mentioned, for vehicle 102 to operate in an autonomous manner, it is important that the vehicle 102 has an expected level of communication with an external system 199. It can be potentially catastrophic for the vehicle 102 to lose communication with an external navigation system 199, hence, if the vehicle 102 can be configured to anticipate the signal loss and have various contingency processes available to enact (as described herein), the operational safety of the vehicle 102 can be enhanced versus an AV that simply loses navigation signals from an external system. Accordingly, while inside a tunnel and signal loss has occurred regarding signals (aka first signals) expected to be received from the external system 199, by utilizing signals (aka second signals) generated from onboard sensors/cameras 150A-n regarding the tunnel environment, the vehicle 102 can attempt to continue in an autonomous manner, wherein the vehicle 102 can be “self-navigating” autonomously based on the signals generated from onboard sensors/cameras 150A-n.

It is to be appreciated that while various embodiments are presented herein regarding a vehicle 102 utilizing signals/data from the onboard sensors/cameras 150A-n to supplement navigation signals received from the external system 199, one or more embodiments can be directed to the vehicle 102 simply attempts to navigate a tunnel with what navigation signals vehicle 102 receives from the external system, and in an event that the volume/quality of navigations signals drops below a minimum level for the vehicle 102 to safely navigate a tunnel, the vehicle 102 simply slows and parks and awaits a driver to operate the vehicle 102.

In an embodiment, the signal component 160 can be configured with various operational thresholds configured to measure any suitable parameter, e.g., signal strength, signal quality, signal fidelity, signal integrity, signal continuity, and suchlike, as are utilized in the application of navigation systems and AVs. An example threshold can be utilized to distinguish between (a) a signal received from an external system that is acceptable for autonomous vehicle operation and (b) a signal received from an external system that has quality issues such that operation of the autonomous vehicle has an unacceptable level of danger/risk. Accordingly, when the signal strength (e.g., of signals 190A-n) is above the threshold (e.g., situation (a)) the vehicle 102 can operate autonomously, but when the signal strength (e.g., of signals 190A-n) is below the threshold (e.g., situation (b)) the vehicle 102 should not/cannot be operated in an autonomous manner. Based upon whether the signal strength has dropped below the threshold of acceptable signal quality or not, the signal component 160 can generate an autonomous mode notification (AMN) 161, wherein the AMN 161 can respectively indicate whether the vehicle 102 is to operate in an autonomous manner, a self-navigating mode, vehicle 102 should pullover (if possible) and stop, etc. The AMN 161 can be transmitted to the navigation component 142 instructing the navigation component 142 to operate the vehicle 102 autonomously, requires assistance from an occupant of the vehicle 102, etc. In an embodiment, in the event that vehicle 102 is being operated in a non-autonomous manner (e.g., Level 0 of SAE J3016), operation of the signal component 160 can generate notifications 167A-n to be utilized to present a warning on the HMI 118 and screen 119 to notify the driver of vehicle 102 of the loss of signals 190A-n being received by the vehicle 102.

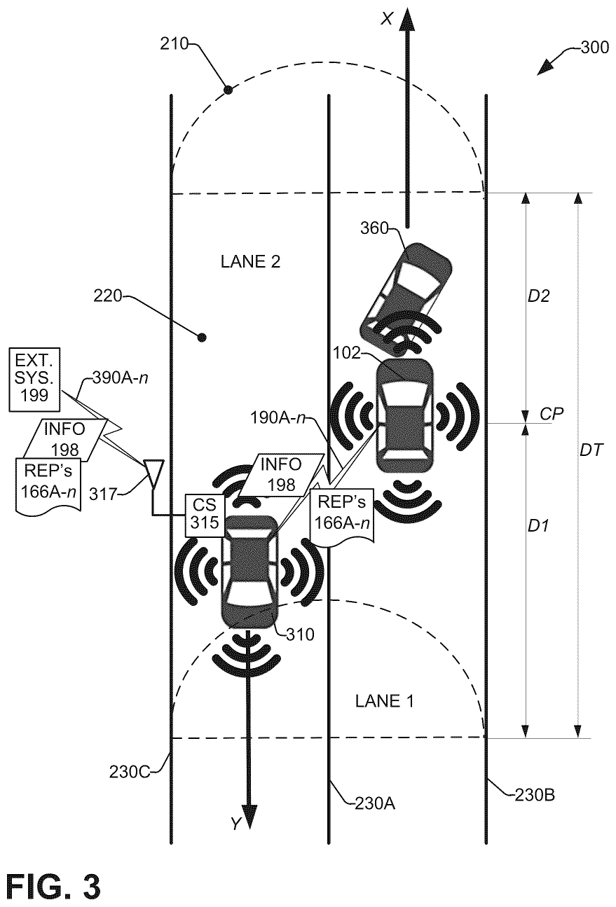

The tunnel component 155 can further include a vehicle detection component (VDC) 163 which can be configured to identify and monitor operation (e.g., motion, direction) of another vehicle (e.g., a second vehicle, vehicle 310 driving in direction y, per FIG. 3), that is also navigating the road being navigated by the vehicle 102. The vehicle detection component 163 can be configured to interact with a similar communication system operating on the other vehicle (e.g., vehicle 310) such that information can be passed between vehicle 102 and the other vehicle (e.g., vehicle 310), wherein the information can include a status report 166A-n. As further described, vehicle 102 can utilize the other vehicle (e.g., vehicle 310) to be a go between in transmitting information between vehicle 102 and the external system 199. In an embodiment, the other vehicle may have communications with an external system 199 (e.g., operating as a GNSS, GPS), wherein the other vehicle can be configured to forward any navigation data received from the external system 199 to the vehicle 102, thus enabling vehicle 102 to autonomously navigate a tunnel.

As previously mentioned, the tunnel component 155 can further comprise various algorithms 164A-n respectively configured to determine information, make predictions, etc., regarding any of the road being navigated, a tunnel being navigated, severity of an accident, motion of passengers within the vehicle 102, location of vehicle 102 within a tunnel, signal strength of communications between vehicle 102 and an external system, and suchlike. Algorithms 164A-n can include a computer vision algorithm(s), a digital imagery algorithm(s), position prediction, velocity prediction, motion prediction, and suchlike, to enable the respective determinations, predictions, etc., per the various embodiments presented herein.

An incident component 165 can be further included in the tunnel component 155, wherein the incident component 165 can be configured to determine a current status of the vehicle 102. For example, the incident component 165 can be configured to determine whether vehicle 102 is unable to continue to navigate the tunnel in an autonomous manner, if the vehicle 102 requires the occupant to take over navigation/driving, whether the vehicle 102 has been involved in an accident within a tunnel, and suchlike. The incident component 165 can be configured to generate one or more status reports 166A-n regarding a current operational state of vehicle 102, e.g., location of vehicle 102 within a tunnel, operational state of vehicle 102, physical state of occupant(s) (if any), and suchlike. Further, the status reports 166A-n can be generated even though vehicle 102 was not involved in an accident, but rather, for example, has stopped operating autonomously within the tunnel and is awaiting/undergoing operation by an occupant, as further described. The incident component 165 can be further configured to present notifications 167A-n to an occupant of vehicle 102, wherein the notifications 167A-n can be presented via one or more screens 119 on a human-machine interface (HMI) 118, as further described herein.

The vehicle 102 can further include a communications component 170, e.g., communicatively coupled to the OCS 110. The communications component 170 can be configured to scan for signals being generated by external systems, wherein in an embodiment, the external system can be another vehicle, e.g., a second vehicle, proximate to vehicle 102. In response to detecting signals being sourced from the second vehicle, the communications component 170 can establish communications with the second vehicle and utilize the second vehicle as a go between for transmission of status reports 166A-n and suchlike between vehicle 102 and another external system such as GNSS, an insurance company, medical services, an emergency contact, and suchlike. The communications component 170 can be configured to transmit a status report 166A-n, and can be further configured to label the status report 166A-n with the respective entity to which the status report 166A-n is to be transmitted to by the communications system (e.g., a second communication system) located on the second vehicle.

The vehicle 102 can further include a database comprising GPS data/map 185, wherein the database can be configured to store information regarding various routes, emergency services, auto garages, etc., that have been previously navigated and/or are to be navigated by vehicle 102. The GPS data/map 185 can be supplemented by information (tunnel data 159) gathered during operation of the vehicle 102.

As shown in FIG. 1, the OCS 110 can further include a processor 112 and a memory 114, wherein the processor 112 can execute the various computer-executable components, functions, operations, etc., presented herein. The memory 114 can be utilized to store the various computer-executable components, functions, code, etc., as well as tunnel data 159, AMN 161, algorithms 164A-n, status reports 166A-n, and suchlike (as further described herein). In an embodiment, the vehicle operation components 140 can form a standalone component communicatively coupled to the OCS 110, and while not shown, the vehicle operation components 140 can operate in conjunction with a processor (e.g., functionally comparable to processor 112) and a memory (e.g., functionally comparable to memory 114) to enable navigation, steering, braking/acceleration, etc., of vehicle 102 to a destination. In another embodiment, the vehicle operation components 140 can operate in conjunction with the processor 112 and memory 114 of the OCS 110, wherein the various control functions (e.g., navigation, steering, braking/acceleration) can be controlled by the OCS 110. Similarly, the tunnel component 155 can form a standalone component communicatively coupled to the OCS 110, and while not shown, the tunnel component 155 can operate in conjunction with a processor (e.g., functionally comparable to processor 112) and a memory (e.g., functionally comparable to memory 114) to enable safe operation when signal loss has occurred, e.g., during operation of vehicle 102. In another embodiment, the tunnel component 155 can operate in conjunction with the processor 112 and memory 114 of the OCS 110, wherein the various signal-loss related functions can be controlled by the OCS 110. In a further embodiment, the OCS 110, vehicle operation components 140, and the tunnel component 155 (and respective sub-components) can operate using a common processor (e.g., processor 112) and memory (e.g., memory 114).

As further shown, the OCS 110 can include an input/output (I/O) component 116, wherein the I/O component 116 can be a transceiver configured to enable transmission/receipt of information 198 (e.g., tunnel data 159, status reports 166A-n, and the like) between the OCS 110 and any external system(s) 199, wherein external system(s) 199 can include, in a non-limiting list, an onboard communication system of another vehicle, a remotely located cellphone or similar computing/communication device, a GNSS data system, a GPS data system, an autonomous geo-spatial positioning system, a PNT system, a cloud-based computing system, a communication system configured to (a) generate/transmit communications, (b) act as a passthrough directing communications to various entities, and suchlike. I/O component 116 can be communicatively coupled, via an antenna 117, to the remotely located devices and systems (e.g., external system 199). Transmission of data and information (e.g., tunnel data 159, status reports 166A-n, and suchlike) between the vehicle 102 (e.g., via antenna 117 and I/O component 116) and the remotely located devices and systems can be via the signals 190A-n. Any suitable technology can be utilized to enable the various embodiments presented herein, regarding transmission and receiving of signals 190A-n. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like.

In an embodiment, as previously mentioned, the OCS 110 can further include a HMI 118 (e.g., a display, a graphical-user interface (GUI)) which can be configured to present various information including imagery of/information regarding a tunnel, vehicle 102, a second vehicle, the road, alarms, warnings, information received from external systems and devices, etc., per the various embodiments presented herein. The HMI 118 can include an interactive display 119 to present the various information via various screens presented thereon, and further configured to facilitate input of information/settings/selections, etc., regarding operation of the vehicle 102.

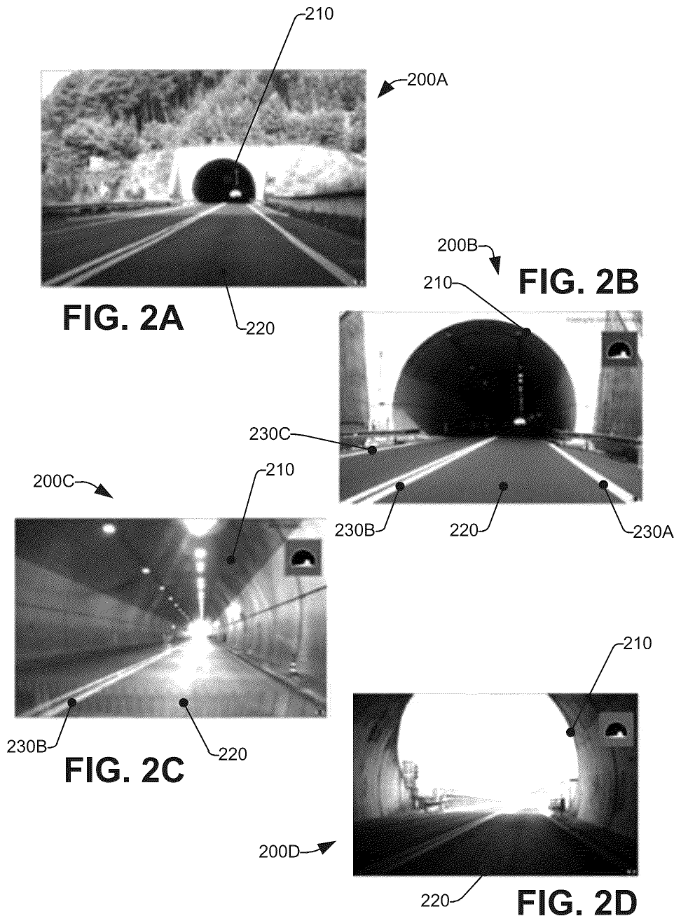

As mentioned, the various sensors/cameras 150A-n and algorithms 164A-n can be utilized to generate images and information regarding the operational environment of vehicle 102. A field of view of a camera 150A and/or field of detection of sensor 150B can include any road markings on the road being navigated by vehicle 102, and further, the presence of a tunnel, wherein, based upon the imagery being captured, vehicle 102 can determine any of (a) a tunnel is approaching, (b) entering the tunnel, (c) driving within the tunnel, and/or (d) exiting the tunnel. Any suitable technology can be utilized in determining the presence of a tunnel and the location of vehicle 102 relative to the tunnel, for example, finite state machine (FSM) architecture. FIGS. 2A-2D, images 200A, 200B, 200C, and 200D illustrate respective situations regarding a vehicle 102 navigating a tunnel on a road (the images can be generated by sensors/cameras 150A-n). In a first situation (image 200A) vehicle 102 detects presence of a tunnel 210 on a road 220. Image 200B illustrates the tunnel 210 as it is being entered by vehicle 102. As well as detecting the tunnel 210, the various onboard systems can also detect the presence of road markings 230A-n, where in FIGS. 2A-2D, line markings 230A, 230B, and 230C indicate two lanes LANE 1 and LANE 2. Image 200C presents a view from within the tunnel 210 as it is being navigated by vehicle 102. Image 200D presents a view as the vehicle 102 is exiting the tunnel 210. The road markings 230A-n can indicate roadside kerb/curb structures, as well as indicating lane markings such as white and/or yellow painted stripes indicating a road edge, road/pavement interface, slow lane, fast lane, bus lane, bike lane, pedestrian lane, etc., where the stripes can be a continuous line or a broken pattern. Lane markings can also be indicated by other techniques, such as white stones, rumble strips, reflective beads or surfaces located on or in a road surface, such as reflective studs colloquially termed “cat's eyes”, and such like. As mentioned previously, the tunnel detection component 158 can be configured to compile tunnel data 159 regarding the presence of a tunnel (e.g., tunnel 210), lane markings (e.g., road markings 240A-n), and suchlike.

FIG. 3, schematic 300, illustrates a scenario of application for the various embodiments presented herein. FIG. 3 illustrates a road 220 comprising two lanes, LANE 1 and LANE 2, which are respectively marked with lane markings 230A, 230B, and 230C. Road 220 goes through a tunnel 210. The scenario presented in FIG. 3 depicts vehicle 102 having collided with a vehicle 360, which has accordingly curtailed vehicle 102′s progress along LANE 1 in direction X. However, in another scenario (not shown), vehicle 102′s progress in tunnel 210 could have been curtailed as a result of the navigation and steering components (e.g., navigation component 142) onboard vehicle 102 can no longer control operation of vehicle 102 in a safe manner (e.g., in the absence of navigation signals from an external system) and the vehicle 102 has stopped for a human operator to take over (as further described) and accordingly, vehicle 360 would not be present/involved in such a scenario and thus would not be depicted on FIG. 3.

In an embodiment, upon detection of a tunnel 210, (per FIG. 2A) the tunnel detection component 158 can communicate with an external system 199 and request information regarding the tunnel 210, e.g., what is the length DT of the tunnel?, wherein external system 199 can respond with a value. In an example scenario, external system 199 indicates that length DT of the tunnel 210 is 800 metres/0.5 miles. Upon entering the tunnel 210, the vehicle 102 can employ the various sensors/cameras 150A-n in conjunction with algorithms 164A-n to perform a self-navigating/dead reckoning approach to autonomously driving vehicle 102 rather than relying on external data (e.g., from a GNSS, GPS). For example, upon entering the tunnel 210, a self-navigating process can occur, whereby the various sensors/cameras 150A-n and algorithms 164A-n in conjunction with navigation component 142 can determine a distance D1 driven by the vehicle 102 inside of the tunnel. Hence, in an example scenario, the external system 199 provided information 198 indicating that the tunnel 210 is 800 metres long, however, the vehicle 102 is involved in an accident at D1=500 metres/0.3 miles into the tunnel. Based upon the knowledge of how long the tunnel is, and a distance driven, the vehicle 102 can make a determination that the vehicle 102 is located 500 metres from one tunnel entrance, and D2=300 metres/0.2 miles from the other entrance. Hence, if there are any occupants onboard vehicle 102 that prefer to exit the tunnel rather than remain with vehicle 102, the HMI 118 can present information regarding the tunnel 210, e.g., distances D1 and D2, from which the occupant(s) can determine the direction they want to walk to exit the tunnel. The information presented on HMI 118 can be supplemented with other, already known, information (e.g., in GPS/DATA MAP 185, tunnel data 159), such as there is a police station, medical center, automotive dealer, restaurant, etc., located near one end of the tunnel.

In a further embodiment, as previously mentioned, vehicle 102 can include a VDC 163, wherein the VDC 163 can be configured to identify the presence of another vehicle 310 (a second vehicle) in the tunnel 210. Vehicle 310 can be operating autonomously, semi-autonomously, or non-autonomously. In an embodiment, vehicle 310 can be configured with communication technology enabling communication between vehicle 310 and vehicle 102 (e.g., to facilitate transmission of data therebetween, (e.g., by BLUETOOTH® or similar technology)) and further, communication between the vehicle 310 and the external system 199 (e.g., to enable transmission of a status report 166A from vehicle 102 to the external system 199). As shown in FIG. 3, the vehicle 310 can include an onboard communication system 315 coupled to an antenna 317, wherein the onboard communication system 315 can be configured to receive signals 190A-n from vehicle 102, wherein the signals 190A-n can include one or more status reports 166A-n and/or information 198. The communication system 315 can be configured to communicate with the external system 199 using signals 390A-n generated by the communication system 315 and the external system 199.

In an embodiment, vehicle 102 can utilize the other vehicle 310 to act as a proxy/go-between between vehicle 102 and the external system 199. Accordingly, where the other vehicle 310 has communications with the external system 199, the vehicle 310 can be configured to forward a status report 166A (or any status report 166A-n) from the vehicle 102 to the external system 199. In an embodiment, the status report 166A can include an identifier indicating at least one entity to which the status report 166A is to be directed, wherein the entity can be one of an insurance company, a medical service, a highway patrol, an emergency contact, a global navigation satellite system, or a global positioning system, and suchlike. The identifier in the status report 166A can be utilized by the communication system 315 to identify the specific entity to which the external system 199 can forward the status report 166A to. In another embodiment, where the vehicle 310 has similarly lost communications with the external system 199 while driving in the tunnel 210, the vehicle 310 can be configured to transmit the status report 166A to the external system 199 once communications have been re-established between vehicle 310 with the external system 199, e.g., upon vehicle 310 exiting the tunnel 210. In an embodiment, vehicle 102 can further instruct vehicle 310 to generate and transmit a notification to vehicle 102 indicating that the status report 166A was successfully transmitted to the external system 199.

It is to be appreciated that while the foregoing embodiments describe vehicle 102 communicating with an external system 199, with vehicle 310 acting as an intermediary, the embodiments are not so limited. In another embodiment, vehicle 102 may be able to establish communications with an entity that is not configured to provide navigation data, but operates as a communication system. For example, while vehicle 102 may not be able to communicate with a GNSS, GPS, etc., vehicle 102 may be able to establish direct communication with a telecommunications system (e.g., external system 199 is a cellular telephone network), accordingly, a status report 166A-n can be transmitted from the OCS 110 to the cellular network. Hence, in this example scenario, vehicle 310 does not have to be present for communications between vehicle 102 and external system 199 to occur. In a further embodiment, where an occupant's cellphone has been communicatively coupled to the OCS 110, the OCS 110 can utilize the occupant's cellphone to establish communications between the vehicle 102 and external system 199, e.g., to transmit a status report 166A-n.

### Loss of Navigation Signal—No Occupants in Vehicle

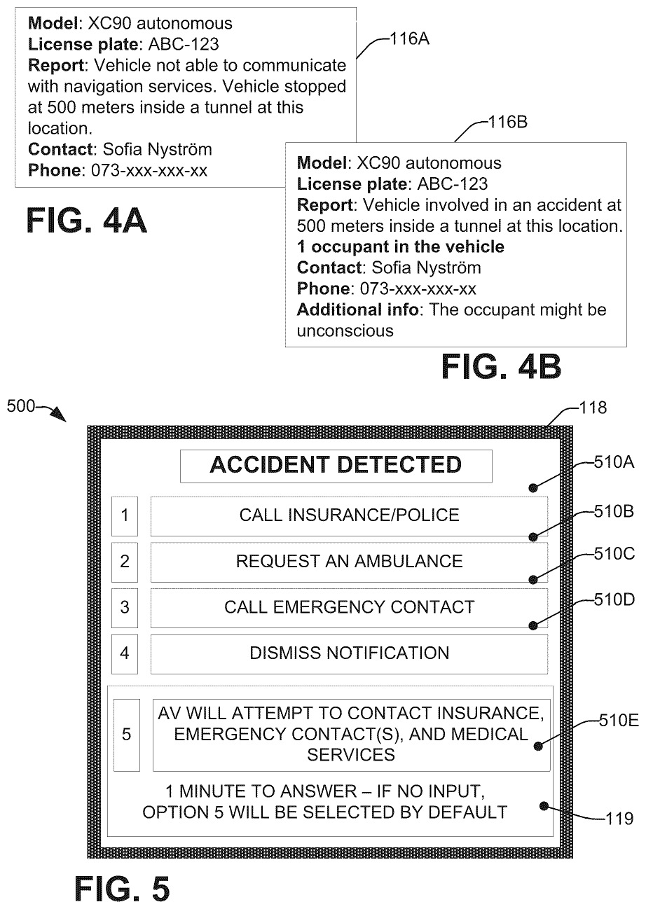

In an embodiment, where there is loss of navigation signal from external system 199, but there are no occupants (e.g., as determined by the various sensors/cameras 150A-n and algorithms 164A-n), vehicle 102 can detect the presence of vehicle 310 and forward a status report 166A to vehicle 310, wherein vehicle 310 can forward the status report 166A to the external system 199, as previously mentioned. In a further embodiment, the status report 166A can be shared with an emergency contact person associated with vehicle 102, an insurance company associated with vehicle 102, a local police force with tunnel 210 in their jurisdiction, a department operating the tunnel 210, and suchlike. FIG. 4A presents an example status report 166A that can be transmitted, in accordance with an embodiment. As shown, the status report 166A can include make of vehicle, license plate, report of current situation, an emergency contact/phone number, and suchlike.

### Loss of Navigation Signal—Occupant(s) in Vehicle

In an example scenario where communication signals have been lost and there are one or more occupants in the vehicle 102, and vehicle 102 is currently unable to autonomously navigate the tunnel 210, the vehicle 102 can be configured to present a notification 167A (e.g., on HMI 118) informing the occupant(s) of vehicle 102′s inability to operate autonomously and an occupant will have to operate/drive vehicle 102 out of the tunnel 210 and/or when communications with the external system 199 have been re-established. A notification 167A can include any suitable text, e.g., “Autonomous Drive Mode: OFF, the vehicle requires driver operation/attention”. In an embodiment, a status report 166A-n can be sent indicating that vehicle 102 is no longer able to be operated autonomously, but is under driver control. In another embodiment, in the event of there is an occupant in vehicle 102 but the occupant is unable to drive vehicle 102 (e.g., occupant doesn't have a driver's license), vehicle 102 can operate as if there is no occupant, per the foregoing.

### Vehicle Involved in Accident—No Occupant(s)

In the event of vehicle 102 being involved in an accident, the incident component 165 can perform various functions to determine whether vehicle 102 had any occupants when the accident occurred. In response to determining that there are no occupants, vehicle 102 can transmit a status report 166A similar to that presented in FIG. 4A, wherein the status report can further include information regarding the collision location, and suchlike. Accidents involving the vehicle 102 can include colliding into another vehicle, a person, a wall of the tunnel, and the like.

### Vehicle Involved in Accident—At Least One Occupant

In the event of an occupant(s) being in vehicle 102 at the time of the accident, the incident component 165 can attempt to communicate with the occupant to determine what the next action(s) should be. In an embodiment, the incident component 165 can wait for a period of time to elapse and in response to determining that there has been no interaction between an occupant and the vehicle 102 (e.g., no communication detected via a microphone onboard vehicle 102) the incident component 165 can initiate (e.g., automatically) one or more actions being performed. Such actions can include contacting medical services, the police, a contact person associated with vehicle 102, an insurance company associated with vehicle 102, a highway department operating the tunnel 210, and suchlike. FIG. 5, screen 500, presents example information that can be presented when an AV is involved in an accident, in accordance with at least one embodiment. In an embodiment, various options 510A-n can be presented for interaction with an occupant of the vehicle 102. The options can be presented on a screen 119 on HMI 118. The first four example options 510A-D can be selected by an occupant of the vehicle 102, such as call insurance/police, request an ambulance, call the emergency contact, dismiss the notifications. In the event of there is no response from the occupant (e.g., occupant is unconscious from the accident), after a period of time has elapsed since the accident occurred (e.g., 15 seconds after the sensors 150A-n indicated a collision had occurred) the onboard system (e.g., incident component 165) can initiate a call to insurance, emergency contact, medical services, etc. (e.g., via I/O component 116 and signals 190A-n.)

In another embodiment, a status report 166A can be transmitted via a second vehicle 310 to the respective receiving entity, as previously described. FIG. 4B presents an example status report 166B that can be transmitted, in accordance with an embodiment. As shown, the status report 166B can include make of vehicle, license plate, report of current situation, an emergency contact/phone number, further, the status report 166B can provide information regarding a number of occupants in the vehicle 102 and their current condition, e.g., a single occupant who may be unconscious (per data received from sensors/cameras 150A-n). The status report 166B can further include information regarding the location of vehicle 102 as well as a damage report as determined by onboard sensors/cameras 150A-n, such as more than one tire is punctured, vehicle cannot be driven, etc.

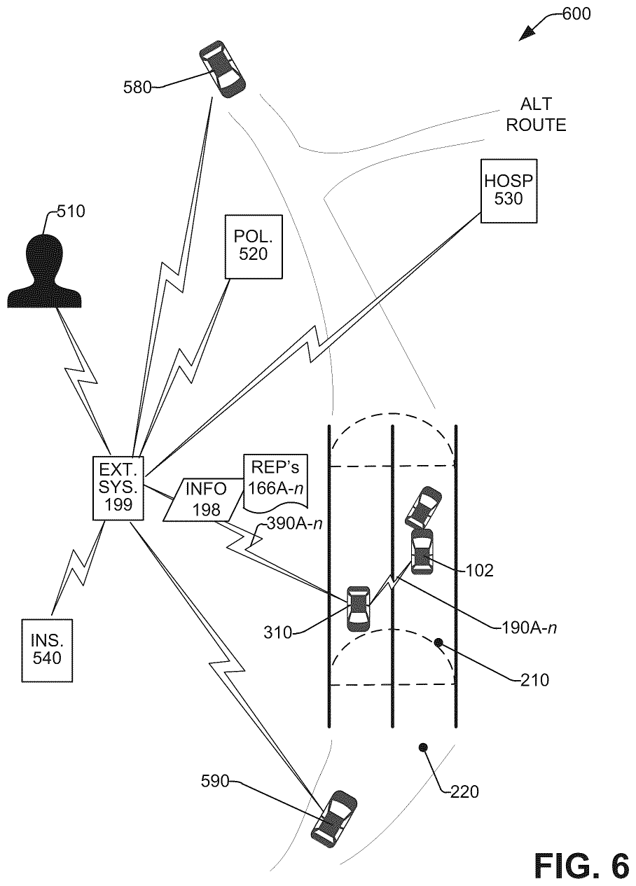

Turning to FIG. 6, schematic 600 presents an example scenario of information in a status report (e.g., any of status reports 166A-n) being distributed to various entities, in accordance with an embodiment. As illustrated in FIG. 6, various information 198 and status reports 166A-n can be generated, e.g., by incident component 165, and transmitted to other entities, e.g., via the second vehicle 310. As previously described, the communication system 315 onboard the second vehicle can transmit (via signals 390A-n) the information 198 and status reports 166A-n to the external system 199. In an embodiment, the external system 199 can be a navigation system such as GNSS, GPS, etc. In a further embodiment, the external system 199 can be a communication system configured to distribute/transmit the information 198 and status reports 166A-n to respective entities. Such entities can include an emergency contact 610 (e.g.,

Sofia Nystrom in example status reports in FIGS. 4A and 4B), a local police force/highway patrol 620, a local emergency services (e.g., hospital, fire service, ambulance) 630, a local insurance office 640, wherein the respective entity can receive the status report 166A-n (e.g., via a communications system, a cellphone, and the like) and act upon it (e.g., hospital 630 dispatches an ambulance). A status report 166C can include a variety of information. For example, the status report 166C can include an indication of the direction/traffic lane that the vehicle 102 was travelling at the time of the accident. Accordingly, emergency services 620 and 630 can use the direction information to determine a direction to approach the tunnel 210. Owing to the constriction of lanes in a tunnel, it might be quicker, more effective, for an emergency services vehicle to arrive from the direction opposite to that which the vehicle 102 was travelling as the traffic from this direction may be suffering from less traffic congestion (traffic jam) than the traffic that is approaching the tunnel 210 in the same direction as vehicle 102 was.

In a further embodiment regarding communications to a designated emergency contact person 610. In the event of the contact person's phone is in the vehicle 102 (e.g., the primary contact person is travelling in vehicle 102), the status report 166A can be forwarded to a designated emergency contact who is not currently in the vehicle 102, e.g., a second or third emergency contact.

In another embodiment, as shown in FIG. 6, the status report 166A-n generated by vehicle 102 (and potentially forwarded by the second vehicle 310) can be distributed to other vehicles in the area that have an interest in knowing the current traffic conditions at the tunnel 210. For example, a third vehicle 680, upon receiving a status report 166F regarding an accident occurring within the tunnel 210, the vehicle 680 (e.g., via a computer system onboard vehicle 680) can be configured to make a determination that it would be quicker to detour around the tunnel 210 via an alternative route. In a further embodiment, where there are multiple lanes available to navigate tunnel 210, a fourth vehicle 690 can make a determination that it will maintain its present course that includes driving through tunnel 210, but vehicle 690 will drive through the tunnel using a different lane (e.g., a second lane) to that used by the vehicle 102.

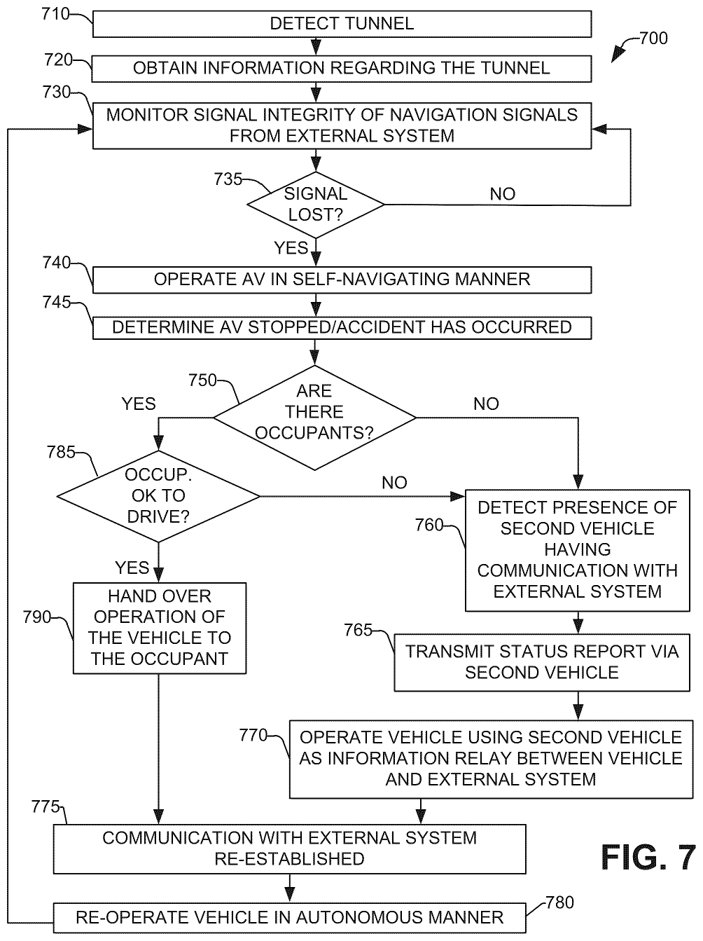

FIG. 7 illustrates a flow diagram 700 for a computer-implemented methodology for a vehicle being operated autonomously while driving in a tunnel, in accordance with at least one embodiment.

At 710, an AV (e.g., vehicle 102, a first vehicle) can detect the presence of a tunnel (e.g., tunnel 210). During operation of the AV, the AV can be in communication with an external navigation system (e.g., external system 199), wherein the external system can be a GNSS or suchlike configured to provide navigation information to the AV.

At 720, as the AV is approaching the tunnel, the AV can obtain information regarding the tunnel. In an embodiment, the information can identify the length (e.g., FIG. 3, DT) of the tunnel. In an embodiment, the information can be obtained from a mapping database (e.g., GPS data/map 185) storing information previously obtained by the vehicle 102 (e.g., by

OCS 110). In another embodiment, the information can be obtained from the external system (e.g., external system 199).

At 730, during operation of the AV, various onboard systems (e.g., signal component 160) can be continually monitoring the quality of signals being received from the external system, to determine a risk on whether the signals may be lost, and effectively, the AV will be self-navigating (e.g., operating without assistance/data from the external system).

At 735, a determination can be made (e.g., by the signal component 160) regarding whether the signal quality from the external system is deteriorating to the point of deleteriously affecting the autonomous operation of the AV and/or the signal has been lost. In response to a determination that NO, the signals have not been lost/deteriorated, methodology 700 can return to step 730, for further signal analysis/monitoring to be performed.

At 735, in response to a determination that YES the signal has been lost/deteriorated, methodology can advance to step 740. In an embodiment, as mentioned herein, the quality and reliability of the signals can be deleteriously affected as a function of entering a tunnel (e.g., tunnel 210). In another embodiment, the quality and reliability of the signals can be lost as a function of operating environment such as within a city, etc., as previously mentioned. At 740, the AV can be configured to operate in a “self-navigating manner”, wherein the AV can switch operations from relying on the various signals (aka first signals) received from the external system, and rather, navigates a tunnel/road using data and information (aka second signals) compiled from onboard sensors/cameras (e.g., sensors/cameras 150A-n) and/or processed by algorithms 164A-n.

At 745, a determination can be made as to whether the AV has stopped or an accident has occurred. As previously mentioned, motion sensors (accelerometers) onboard the AV can be configured to detect a change in motion (e.g., abrupt as can result from a collision, controlled as can result from braking) of the AV.

At 750, a determination can be made regarding whether there are one or more occupants in the AV at the time of the deceleration. As previously mentioned, motion sensors, seat/pressure sensors, microphones, etc., (sensors/cameras 150A-n) onboard the AV can be configured to detect a respective motion of an occupant, a noise of an occupant (whether it be the sound of motion, an utterance, and the like). Further, the presence of an occupant can be determined based upon the occupant interacting with the AV (e.g., via HMI 118), motion detected, etc., prior to the AV decelerating. In the event of NO, no occupant is present in the AV, the methodology 700 can advance to 760 wherein a determination of the presence of a second vehicle (e.g., vehicle 310) can be performed based on, for example, communications being established with the second vehicle (e.g., by signal component 160 interacting with a communication system onboard the second vehicle 310).

At 765, in the event of second vehicle is in the vicinity of the AV, the AV can generate and transmit (e.g., by communications component 170) a status report (e.g., status report 166B) indicating the current operational status of the AV (e.g., is unable to operate autonomously, has been in a collision, etc.). The status report can be transmitted to the second vehicle. As mentioned previously, the status report can also be transmitted via a telecommunications system (e.g., a cellular network) that one or more components/devices onboard the AV has communications with (hence, removing the necessity of the second vehicle relaying the status report).

At 770, in an embodiment, the second vehicle can act as a relay system for the AV, wherein the second vehicle can be in communication with the external system and can transmit/forward the status report received from the AV to the external system. In an embodiment, the second vehicle may be in communications with the external system while the second vehicle is driving through the tunnel (e.g., tunnel 210) and the status report received from the AV can be immediately transmitted to the external system. In another embodiment, communications between the second vehicle and the external system may be hampered by the tunnel, whereupon the second vehicle can transmit the status report once the communications have been re-established, e.g., when the second vehicle is exiting the tunnel.

At 775, communication with the external system can be re-established, e.g., as the AV navigates towards the exit of the tunnel. For example, an onboard communications component (e.g., signal component 160, communications component 170) re-establishes communications with the external system.

At 780, with the communications re-established (e.g., the AV is exiting or has exited the tunnel) the AV can return to operating in an autonomous manner with signal interactions (e.g., via signals 190A-n) between the AV and the external system. Methodology 700 can return to 730, wherein monitoring of signal integrity between the AV and the external system can continue to be performed, as previously described.

Returning to 750, in the event of a determination that YES, there is at least one occupant in the AV, the methodology can advance to 785. At 785, a determination can be made regarding whether the occupant is OK to operate the AV, e.g., drive the AV such that the AV is operating non-autonomously or semi-autonomously. In a first scenario where the AV was unable to operate in an autonomous manner owing to a loss of navigation signals between the AV and the external system in conjunction with the AV is unable to navigate the tunnel (e.g., due to an unacceptable level of safety) the occupant can be requested to operate the AV, wherein the request can be via a notification (e.g., presented on the HMI 118). In a first response, the occupant may indicate that they are capable of operating the AV. Methodology can advance to 790, whereupon operation of the AV is transferred (e.g., by the navigation component 142) to be under the control of the occupant, e.g., the occupant is now steering the AV, and eventually steers the AV out of the tunnel. The methodology can continue to 775 whereupon communications can be re-established between the AV and the external system, and at 780, the AV can return to autonomous operation (as previously mentioned).

Returning to 785, in response to a determination that the occupant is not OK to drive, methodology 700 can advance to 760, as previously described. In an example scenario, the occupant may not be capable to operate the AV as they do not have a driving license. In another example scenario, the occupant may not be physically able to drive, e.g., as a result of an injury sustained during the accident, the driver is unconscious, and suchlike.

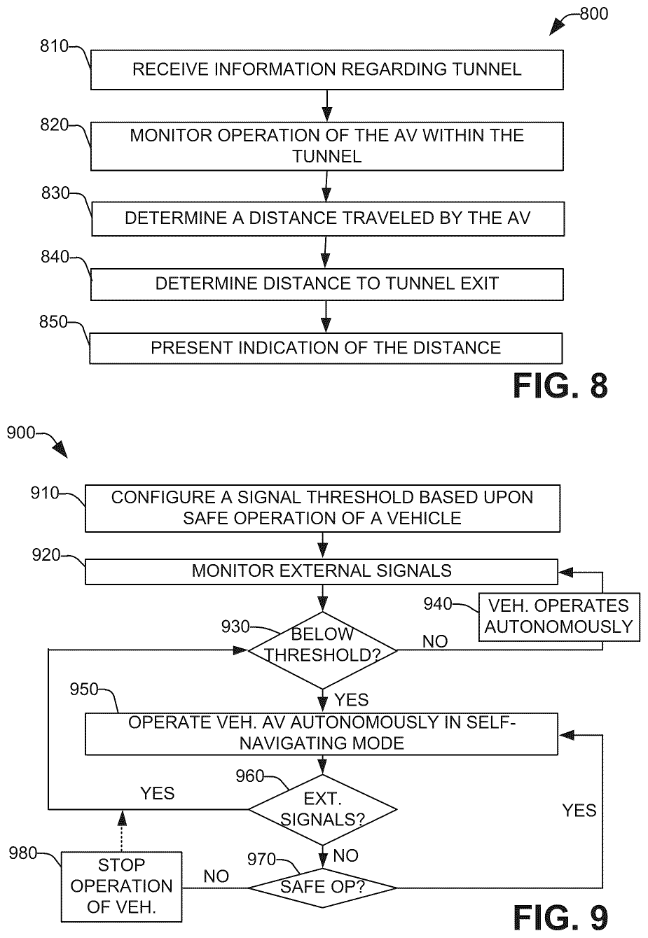

FIG. 8, illustrates a flow diagram 800 for a computer-implemented methodology for determining the nearest exit of a tunnel, in accordance with at least one embodiment.

At 810, an AV (e.g., vehicle 102) can obtain information regarding the tunnel (e.g., tunnel 210). In an embodiment, the information can identify the length (e.g., FIG. 3, DT) of the tunnel. In an embodiment, the information can be obtained from a mapping database (e.g., GPS data/map 185) storing information previously obtained by the vehicle 102 (e.g., by OCS 110). In another embodiment, the information can be obtained from the external system (e.g., external system 199). The tunnel length data can be stored locally on the AV (e.g., tunnel data 159 stored in memory 114).

At 820, operation of the AV within the tunnel can be self-monitored by an onboard system on the AV, wherein the onboard system can include an odometer configured to measure distance travelled by the AV. Upon entry into the tunnel, a reading of the position of AV as it enters the tunnel can be recorded and saved (e.g., in the tunnel data 159).

At 830, the current position (FIG. 3, CP) of the AV can be recorded as the AV navigates the tunnel, wherein the current position can be the location at which the AV was involved in an accident, the location at which the AV ceased autonomous operation, and suchlike, as previously described.

At 840, based upon the current position CP of the AV, versus the length of the tunnel DT, the respective distance to each end of the tunnel can be determined. As previously mentioned, the AV may have a collision within a tunnel that is 800 m long, with CP determined to be 500 m (D1) from the entry point of the tunnel. Accordingly, per FIG. 3, a determination can be made (e.g., by tunnel detection component 158) that one end of the tunnel is 500 m (D1) away, while a second end of the tunnel is 300 m (D2) away.

At 850, length of the tunnel DT, and the determined distances D1 and D2 can be presented to an occupant in the AV (e.g., via the HMI 118), whereupon, the occupant can use the presented information to make a decision on which direction to walk to exit the tunnel.

FIG. 9 illustrates a flow diagram 900 for a computer-implemented methodology for determining whether an AV should go to self-navigating mode based on signal strength, in accordance with at least one embodiment.

At 910, a signal threshold can be configured (e.g., at signal component 160) regarding a quality of navigation signals (e.g., in signals 190A-n) received from an external system and an ability of a vehicle (e.g., vehicle 102 configured to operate as an AV) to safely operate autonomously. As previously described, if a signal quality is above the threshold, it is considered that the risk of the vehicle having an accident/losing control has an acceptable level of risk. Further, if the signal quality drops below the threshold, then the risk is unacceptable regarding potential for an accident/losing control.

At 920, the external signals received at the vehicle from the external system can be monitored (e.g., by the signal component 160 operating in accordance with the OCS 110, the antenna 117, I/O component 116, and the like).

At 930, in response to a determination that NO, the received external signals are not below threshold, methodology 900 can advance to 940 where the vehicle continues to operate in an autonomous manner, e.g., navigation is based in part on the navigation signals received from the external system. Methodology 900 can further return to 920 for further monitoring of signals received from the external system.

Returning to 930, in response to a determination that YES the received external signals are below threshold, methodology 900 can advance to 950 where the vehicle can be configured to operate autonomously but in a self-navigating mode, such that the vehicle relies (e.g., primarily relies) on information and data sourced from sensors/cameras (e.g., sensors/cameras 150A-n and data generated by algorithms 164A-n) located onboard the vehicle. When switching to self-navigating mode, an instruction (e.g., AMN 161) can be generated (e.g., by signal component 160) and sent to the onboard navigation system (e.g., navigation component 142) indicating that self-navigating mode should be utilized when driving autonomously. Methodology 900 can further advance to 960, wherein the presence of navigation signals transmitted by the exterior system can be further monitored for (e.g., by signal component 160).

In response to a determination at 960 that NO navigation signals are present, methodology 900 can advance to 970, wherein a determination (e.g., by navigation component 142) can be made regarding whether, in the absence of navigation signals being received/available from the external system, the vehicle is able to be navigated in a manner having an acceptable risk of collision. In response to a determination that YES, the vehicle can be driven safely in the self-navigating mode, the methodology 900 can return to 950 with the vehicle operating in self-navigating mode.

At 970, in response to a determination that NO, safe operation of the vehicle cannot be assured based on the sensor data generated in the self-navigating mode, methodology 900 can advance to 980, wherein self-navigating operation of the vehicle can be curtailed, e.g., the vehicle can be pulled over the side of the road, an occupant can take over navigation, etc. In an embodiment, as shown by the broken line, radio signals within the tunnel can be continuously monitored and in the event of navigation signals from the external system can be detected and utilized, methodology 900 can return to 930 for further operation of the vehicle, where a further determination can be made regarding whether the navigation signals are above or below the set threshold of signal quality.

### Example Applications and Use

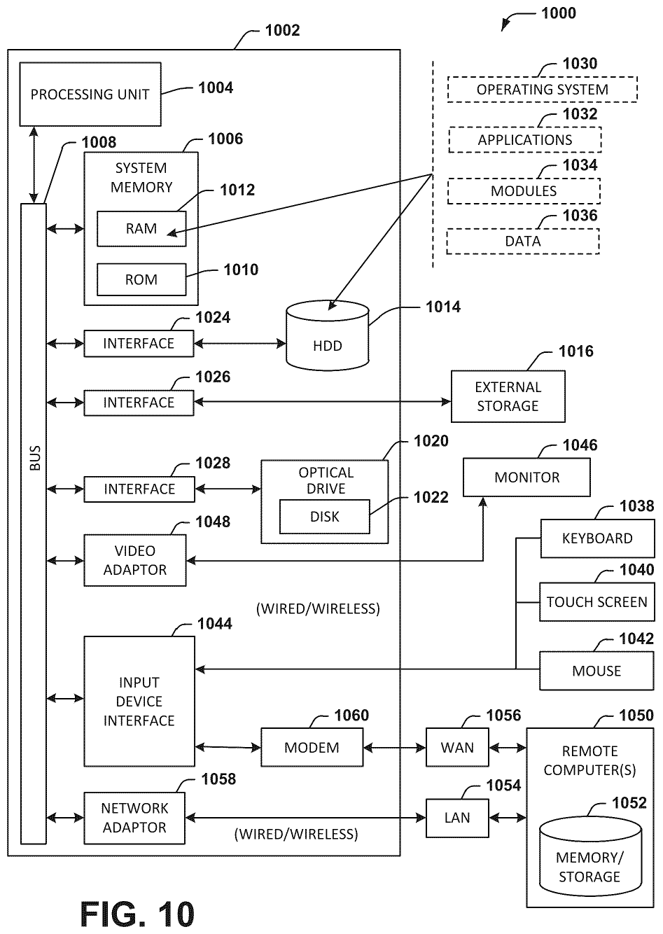

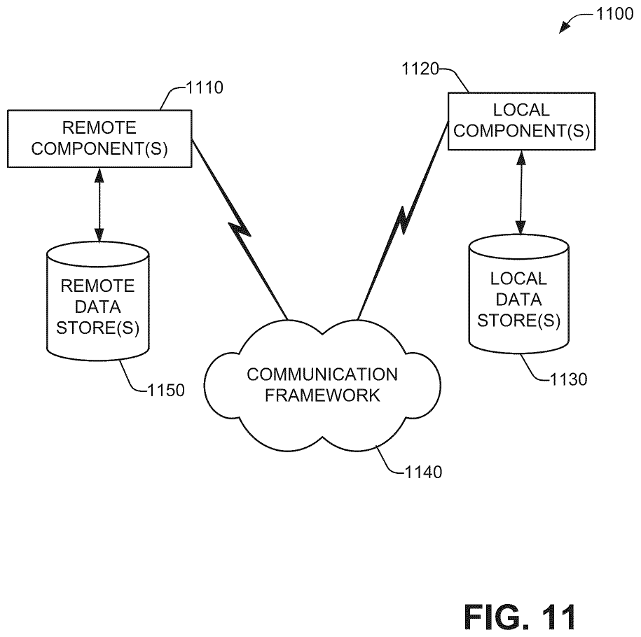

Turning next to FIGS. 10 and 11, a detailed description is provided of additional context for the one or more embodiments described herein with FIGS. 1-9.

In order to provide additional context for various embodiments described herein, FIG. 10 and the following discussion are intended to provide a brief, general description of a suitable computing environment 1000 in which the various embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types.

Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors and may include a cache memory. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can comprise a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1094 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

Referring now to details of one or more elements illustrated at FIG. 11, an illustrative cloud computing environment 1100 is depicted. FIG. 11 is a schematic block diagram of a computing environment 1100 with which the disclosed subject matter can interact. The system 1100 comprises one or more remote component(s) 1110. The remote component(s) 1110 can be hardware and/or software (e.g., threads, processes, computing devices). In some embodiments, remote component(s) 1110 can be a distributed computer system, connected to a local automatic scaling component and/or programs that use the resources of a distributed computer system, via communication framework 1140. Communication framework 1140 can comprise wired network devices, wireless network devices, mobile devices, wearable devices, radio access network devices, gateway devices, femtocell devices, servers, etc.

The system 1100 also comprises one or more local component(s) 1120. The local component(s) 1120 can be hardware and/or software (e.g., threads, processes, computing devices). In some embodiments, local component(s) 1120 can comprise an automatic scaling component and/or programs that communicate/use the remote resources 1110 and 1120, etc., connected to a remotely located distributed computing system via communication framework 1140.

One possible communication between a remote component(s) 1110 and a local component(s) 1120 can be in the form of a data packet adapted to be transmitted between two or more computer processes. Another possible communication between a remote component(s) 1110 and a local component(s) 1120 can be in the form of circuit-switched data adapted to be transmitted between two or more computer processes in radio time slots. The system 1100 comprises a communication framework 1140 that can be employed to facilitate communications between the remote component(s) 1110 and the local component(s) 1120, and can comprise an air interface, e.g., Uu interface of a UMTS network, via a long-term evolution (LTE) network, etc. Remote component(s) 1110 can be operably connected to one or more remote data store(s) 1150, such as a hard drive, solid state drive, SIM card, device memory, etc., that can be employed to store information on the remote component(s) 1110 side of communication framework 1140. Similarly, local component(s) 1120 can be operably connected to one or more local data store(s) 1130, that can be employed to store information on the local component(s) 1120 side of communication framework 1140.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “client entity,” “consumer,” “client entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G or other next generation networks, the disclosed aspects are not limited to a 5G implementation, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service

(GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

While not an exhaustive listing, summarizing various embodiments, but not all embodiments, presented herein:

1. A system, located on a first vehicle operating in an at least partially autonomous manner, comprising: a memory that stores computer executable components; and a processor that executes the computer executable components stored in the memory, wherein the computer executable components comprise: a signal detection component configured to determine a signal quality of first navigation signals received at the first vehicle, wherein the first navigation signals are received from a first external system; and in response to determining the first navigation signals have a signal quality below a threshold of acceptable operation, generate an instruction for the first vehicle to operate utilizing second navigation signals generated by at least one onboard sensor.

2. The system of claim 1, wherein the signal quality of the first navigation signals being below the threshold of acceptable operation is a function of occlusion of the first navigation signals due to the first vehicle driving in a tunnel.

3. The system of claim 1, further comprising an incident component configured to detect the first vehicle stopping.

4. The system of any preceding clause, wherein the first vehicle has stopped as a result of the first vehicle being involved in a collision, while the first vehicle was being driven in a self-navigating mode.

5. The system of any preceding clause, wherein the incident component is further configured to generate a status report, the status report includes information regarding at least one of model type of the first vehicle, license plate number of the first vehicle, a situation report of the first vehicle, a location of the first vehicle, a contact, a contact telephone number, or information regarding an occupant of the first vehicle.

6. The system of any preceding clause, further comprising a communication component configured to establish communication with an external communication system, wherein the external communication system is located on a second vehicle.

7. The system of any preceding clause, wherein the communication component is further configured to transmit the status report to the external communication system located on the second vehicle.

8. The system of any preceding clause, wherein the communication component is further configured to instruct the external communication system on the second vehicle to forward the status report to a second external system.

9. The system of any preceding clause, wherein the second external system is a cloud-based computing system or a remotely located communication system, wherein the second external system is configured to forward the status report to an entity identified in the status report.

10. The system of claim 1, wherein the first external system is configured to transmit the first navigation data to the first vehicle, and comprises a global navigation satellite system (GNSS), a global positioning system (GPS), an autonomous geo-spatial positioning system, or a satellite-based positioning, navigation and timing (PNT) system.

11. A method comprising: determining, by a device comprising a processor located on a vehicle, a first signal quality of first signals received at the vehicle is below a threshold of signal quality for acceptable risk of operation of the vehicle, wherein the first signals comprise first data transmitted from an external system; and switching navigation of the vehicle from operation with the first data received from the external system to operation with second signals comprising second data generated by a first sensor located onboard the vehicle.

12. The method of claim 11, wherein the first signals are received while the vehicle is driving through a tunnel.

13. The method of claim 11, further comprising: determining, by a second onboard sensor, that the vehicle has stopped; in response to determining that the vehicle has stopped, generating a status report detailing a current situation of the vehicle, wherein the current situation is one of: the vehicle is unable to drive with an acceptable level of safety while navigating with the second signals; or the vehicle is involved in a collision.

14. The method of any preceding clause, wherein the status report is configured to be transmitted, via an external communication service, to at least one entity, wherein the entity is one of an insurance company, a medical service, a highway patrol, an emergency contact, a global navigation satellite system, or a global positioning system, wherein the status report includes an identifier identifying the entity to receive the status report.

15. The method of any preceding clause, further comprising: identifying a second vehicle within communication range of the vehicle, wherein the second vehicle includes an onboard communication system configured to communicate with the external communication service; transmitting the combination of status report and identifier to the second vehicle; instructing the second vehicle to transmit the status report to the external communication system; and instructing the second vehicle to transmit a transmission success notification to the vehicle in response to the second vehicle successfully transmitting the status report to the external communication service.

16. The method of any preceding clause, further comprising: determining the vehicle has an occupant; and requesting the occupant operates the vehicle.

17. A computer program product comprising a computer readable storage medium having program instructions embodied therewith, the program instructions executable by a processor to cause the processor to: monitor signal strength of first signals received at a vehicle operating in an at least partially autonomous manner, wherein the first signals are received from an external system and are utilized for navigation of the vehicle; determine a drop in the signal strength of the first signals from a first signal strength to a second signal strength, wherein the first signal strength is acceptable for at least partially autonomous operation of the vehicle based on the first signals and the second signal strength is below a threshold acceptable for the at least partially autonomous operation of the vehicle based on the first signals; and switch navigation of the vehicle to be based on second signals, wherein the second signals are sourced from at least one sensor located onboard the vehicle.

18. The computer program product of claim 17, wherein the drop of signal strength of the first signals from the first strength to the second strength results from the vehicle driving in a road tunnel.

19. The computer program product of claim 17, the program instructions are further executable by the processor to cause the processor to: determine the vehicle has stopped in a road tunnel, wherein the vehicle has stopped owing to: the vehicle is no longer able to navigate the road tunnel in the at least partially autonomous manner; or the vehicle is involved in a collision inside the road tunnel.

20. The computer program product of any preceding clause, the program instructions are further executable by the processor to cause the processor to: generate a status report; identify a second vehicle driving in the road tunnel; and transmitting the status report to the second vehicle, wherein the second vehicle is configured to transmit the status report to an external system, wherein the external system is located outside of the road tunnel.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, located on a first vehicle operating in at least a partially autonomous manner, comprising:
a memory that stores computer executable components; and
a processor that executes the computer executable components stored in the memory, wherein the computer executable components comprise:
a signal detection component configured to determine a signal quality of first navigation signals received at the first vehicle, wherein the first navigation signals are received from a first external system; and
in response to determining the first navigation signals have a signal quality below a threshold of acceptable operation, generate an instruction for the first vehicle to operate utilizing second navigation signals generated by at least one onboard sensor.

2. The system of claim 1, wherein the signal quality of the first navigation signals being below the threshold of acceptable operation is a function of occlusion of the first navigation signals due to the first vehicle driving in a tunnel.

3. The system of claim 1, further comprising an incident component configured to detect the first vehicle stopping.

4. The system of claim 3, wherein the first vehicle has stopped as a result of the first vehicle being involved in a collision, while the first vehicle was being driven in a self-navigating mode.

5. The system of claim 4, wherein the incident component is further configured to generate a status report, the status report includes information regarding at least one of model type of the first vehicle, license plate number of the first vehicle, a situation report of the first vehicle, a location of the first vehicle, a contact, a contact telephone number, or information regarding an occupant of the first vehicle.

6. The system of claim 5, further comprising a communication component configured to establish communication with an external communication system, wherein the external communication system is located on a second vehicle.

7. The system of claim 6, wherein the communication component is further configured to transmit the status report to the external communication system located on the second vehicle.

8. The system of claim 7, wherein the communication component is further configured to instruct the external communication system on the second vehicle to forward the status report to a second external system.

9. The system of claim 8, wherein the second external system is a cloud-based computing system or a remotely located communication system, wherein the second external system is configured to forward the status report to an entity identified in the status report.

10. The system of claim 1, wherein the first external system is configured to transmit the first navigation data to the first vehicle, and comprises a global navigation satellite system (GNSS), a global positioning system (GPS), an autonomous geo-spatial positioning system, or a satellite-based positioning, navigation and timing (PNT) system.

11. A method comprising:
determining, by a device comprising a processor located on a vehicle, a first signal quality of first signals received at the vehicle is below a threshold of signal quality for acceptable risk of operation of the vehicle, wherein the first signals comprise first data transmitted from an external system; and
switching navigation of the vehicle from operation with the first data received from the external system to operation with second signals comprising second data generated by a first sensor located onboard the vehicle.

12. The method of claim 11, wherein the first signals are received while the vehicle is driving through a tunnel.

13. The method of claim 11, further comprising:
determining, by a second onboard sensor, that the vehicle has stopped;
in response to determining that the vehicle has stopped, generating a status report detailing a current situation of the vehicle, wherein the current situation is one of:
the vehicle is unable to drive with an acceptable level of safety while navigating with the second signals; or
the vehicle is involved in a collision.

14. The method of claim 13, wherein the status report is configured to be transmitted, via an external communication service, to at least one entity, wherein the entity is one of an insurance company, a medical service, a highway patrol, an emergency contact, a global navigation satellite system, or a global positioning system, wherein the status report includes an identifier identifying the entity to receive the status report.

15. The method of claim 14, further comprising:
identifying a second vehicle within communication range of the vehicle, wherein the second vehicle includes an onboard communication system configured to communicate with the external communication service;
transmitting the combination of status report and identifier to the second vehicle;
instructing the second vehicle to transmit the status report to the external communication system; and
instructing the second vehicle to transmit a transmission success notification to the vehicle in response to the second vehicle successfully transmitting the status report to the external communication service.

16. The method of claim 13, further comprising:
determining the vehicle has an occupant; and
requesting the occupant operates the vehicle.

17. A computer program product comprising a computer readable storage medium having program instructions embodied therewith, the program instructions executable by a processor to cause the processor to:
monitor signal strength of first signals received at a vehicle operating in an at least partially autonomous manner, wherein the first signals are received from an external system and are utilized for navigation of the vehicle;
determine a drop in the signal strength of the first signals from a first signal strength to a second signal strength, wherein the first signal strength is acceptable for the at least partially autonomous operation of the vehicle based on the first signals and the second signal strength is below a threshold acceptable for the at least partially autonomous operation of the vehicle based on the first signals; and
switch navigation of the vehicle to be based on second signals, wherein the second signals are sourced from at least one sensor located onboard the vehicle.

18. The computer program product of claim 17, wherein the drop of signal strength of the first signals from the first strength to the second strength results from the vehicle driving in a road tunnel.

19. The computer program product of claim 17, the program instructions are further executable by the processor to cause the processor to:
determine the vehicle has stopped in a road tunnel, wherein the vehicle has stopped owing to:
the vehicle is no longer able to navigate the road tunnel in the at least partially autonomous; or
the vehicle is involved in a collision inside the road tunnel.

20. The computer program product of claim 19, the program instructions are further executable by the processor to cause the processor to:
generate a status report;
identify a second vehicle driving in the road tunnel; and
transmitting the status report to the second vehicle, wherein the second vehicle is configured to transmit the status report to an external system, wherein the external system is located outside of the road tunnel.
